(19) United States
(12) Patent Application Publication
(10) Pub. No.: US 2008/0199027 A1
(43) Pub. Date: Aug. 21, 2008

(54) Method of Mixing Audion Signals and Apparatus for Mixing Audio Signals

(76) Inventor: Piotr Kleczkowski, Krakow (PL)

Correspondence Address: DAVID A. GUERRA;INTERNATIONAL PATENT GROUP, LLC, 2025 17TH AVENUE N.W., CALGARY, AB, T2M 0S7, omitted

(21) Appl. No.: 11/997,180

(22) PCT Filed: Aug. 3, 2006
(86) PCT No.: PCT/PL06/00054

§ 371 Date: Jan. 29, 2008

(30) Foreign Application Priority Data
Aug. 3, 2005 (PL) P.376464

(51) Int. Cl. H04B 1/00; G10L 21/00

(52) U.S. Cl. 381/119; 704/201

(57) ABSTRACT

A method of mixing audio signals and apparatus for mixing audio signals, where the method comprises steps of converting of individual digital input audio signals into the time-frequency domain planes (6), processing of the said audio signals in the time-frequency domain, and then summing of the said processed audio signals into the mixed output signal. During the processing at least one privileged element of the audio signals in each time-frequency domain cell is identified, the non-privileged elements of the audio signals are attenuated and the processed audio signals are passed to the summation. The apparatus is operative of performing the method.

The subject of the invention is a method of mixing audio signals as well as apparatus for mixing audio signals. The invention relates both to mixing audio signals in recording studios and to mixing signals from separate audio channels during live performances.

The invention is applicable to any audio material: music, speech or sound effects and for any number of tracks (audio signals) in monophonic recordings or sound reinforcement systems and for any number of tracks (audio signals) mixed down in multichannel systems, both in recordings or in live performances.

According to the known and universally used methods, the process of mixing consists in simply adding sound signals. It is being performed in analogue technology using analogue mixing desks or in digital technology using digital mixing desks or in computers with appropriate software. Most of the mixing desks or mixing software contain tools for manual adjustment of tone colour of separate tracks by a human operator, before they are added. Careful and skilful operators (mixing engineers) can achieve better clarity of the overall mix by adjusting tone colours of separate tracks.

A Polish patent application No P.58531 entitled “A method of increasing the distinctness of a solo sound against acoustical background” discloses an invention concerning a similar technical problem. However, that invention offers only a slight increase of distinctness of only the solo track against the acoustical background and requires that a special background track (typically the accompaniment) is obtained by mixing all tracks but the solo one. Consequently, according to that invention a method of increasing the distinctness consists in dynamic attenuation of the acoustical background depending on the presence of the solo track and is characterised by the time-frequency analysis of the digital signals of the solo track and of the acoustical background in an electronic processing device.

The purpose of the present invention is to develop a method of mixing audio signals as well as apparatus for mixing audio signals providing more perceivable details for human hearing.

The method according to the invention comprises a number of steps. First, digital individual input audio signals are converted from time domain into the time-frequency domain. Individual input audio signals may be also referred to as the tracks, for example representing different musical instruments. Next, the individual audio signals in the time-frequency domain are subject to processing (i.e. signal processing). Finally, the processed audio signals are summed (added) so that in result a mixed output signal is obtained. Naturally, the mixed output signal is a time domain signal. It is important to note that the summation of the processed signals may be performed in the time-frequency domain and the mixed signal is then converted into time domain or, alternatively, the summation is performed after the processed signals are converted from time-frequency domain into the time domain.

The crux of the method according to the invention is the specific processing of the individual audio signals in the time-frequency domain. When the individual input audio signals are converted from time domain into the time-frequency domain (e.g. according to the well-known Fourier transformations) the signals are represented in time-frequency “digitized” plane consisting of indivisible “pixels”, which are referred to as time-frequency domain cells. Therefore, each audio signal represented in time-frequency domain has certain representation in each time-frequency domain cell. The audio signal component pertaining to specific time-frequency domain cell is referred to as an element of the audio signal. According to the invention, from each time-frequency domain cell (i.e. the time-frequency domain having the same address (coordinates) in the time-frequency domain plane) there is identified (chosen) at least one element of the audio signals, the so-called privileged element of the audio signal. Therefore, after the processing, a certain audio track will usually consist of privileged and non-privileged elements of the audio track. Typically, this identification of the privileged elements of the audio signals will be performed for all time-frequency domain cells. Nevertheless, it is also possible that the identification operation will be performed only for a pre-determined sub-domain of the time-frequency domain. The process of determining the sub-domain may be dependent on specific audio characteristic of the mixed audio signals (tracks).

Next, the non-privileged elements of the audio signals are attenuated (to a specific extent of the attenuation). It is important here that the attenuation is understood as a process by which the privileged elements of the audio signals become more distinct (in comparison to the pre-attenuation stage) with regard to the non-privileged elements of the audio signals. Consequently, the attenuation may also denote a process of amplification of the privileged elements of the audio signals, or both operations (attenuation of the non-privileged and amplification of privileged elements of the audio signals). Further, all processed audio signals (comprising privileged and non-privileged elements) are passed for the summation.

It is advantageous when identification of the privileged elements is done by choosing those elements from elements of different audio signals (tracks) in the time-frequency domain cells (having the same address in the time-frequency plane) which are characterised by the highest energy values. Therefore, energy value of the elements of audio signals is preferably used as a privilege determining factor. The privileged elements of the audio signals may be chosen because they exceed certain energy level (absolute or relative). There may be a number (but at least one) of privileged elements of audio signals for the each (specific) time-frequency domain cell. In certain circumstances it is also possible that all elements of audio signals may be identified as privileged for specific time-frequency domain cells. Furthermore, a different number of privileged elements of audio signals may be identified for different time-frequency domain cells. In other words time-frequency domain cells having different address (coordinates) in the time-frequency plane may have different number of privileged elements of audio signals. Another advantageous feature is that there are preferably no more than two privileged elements of audio signals for each time-frequency domain cell.

It is especially advantageous when the time-frequency domain cells are grouped into areas. When this is the case, the privileged elements are identified for each area and not for individual time-frequency cells. The areas are consists preferably of maximum 500 neighbouring time-frequency domain cells. The areas are usually formed in such a way so that they embrace a specific component of the sound of a audio signal (e.g. a music instrument). The specific component may be a harmonic of a specific musical note or its other characteristic feature. Determining of the areas must also take into account the other audio signals to be mixed, consequently, such areas should be determined for each specific set of audio signals. The rule of the shaping of areas is important for the overall quality of sound obtained. The goal of the effective shaping-assignment procedure is to preserve all characteristic shapes of time-frequency patterns of a given track (instrument), as long as they can be perceived in the mixed output signal. There is a contradiction between the shapes of the areas preserving the characteristic details of a given instrument and these shapes being smooth. Smoothness increases the overall clarity of the mix, but when the shapes are too smooth some details may be lost resulting in perceptible distortion. It is not possible to determine a priori which of the mathematical tools for computing the shapes of the areas will provide the best balance between smoothness and detail. It is therefore crucial to apply an successful methods (deterministic or probabilistic) for shaping the areas. Experiments prove that neural networks or fuzzy logic methods may be successfully applied in order to determine areas taking account sound absolute and relative characteristics of all audio signals (tracks) to be mixed. Naturally, the areas should be determined before the identification of privileged elements of the audio signals takes place. Once the areas are formed it is advantageous to average the energy values of all elements of the audio signal pertaining to the area. To avoid ambiguity, a collection of elements of audio signals (audio signal components of individual time-frequency domain cells) pertaining to a specific area are referred to as constituents of the audio signals. In result, instead of comparing energy values of individual elements in each time-frequency domain cells, the averaged energy values of constituents of audio signals are compared for determined areas. All described above peculiarities concerning the elements of audio signals and identification of the privileged elements of audio signals are also applicable to the constituents of the audio signals, specifically since they are collections thereof.

It is sometimes also advantageous when the energy values of the elements of the audio signals (as well as the averaged energy values of the constituents of the audio signals) are multiplied by a coefficient with a value from 0, 1 to 10, before the identification of the privileged elements of the audio signals (or the privileged constituents of the audio signals) takes place. The multiplied value is used in the process of identifying privileged elements (constituents). Once the identification is performed, the actual elements (constituents) of the audio signals passed to the process of summing are original (i.e. non-multiplied). This option is useful in those cases, where one or several signals (or their parts) are to be treated in a different way than the others, i.e. are to be given additional priority (coefficient value higher than 1) in the process of identification of the privileged elements (constituents) of the audio signals, or are to be weakened (coefficient value less than 1) in the same process.

The attenuation of the non-privileged elements of the audio signals (or non-privileged constituents of the audio signals), which takes place after the process of choosing the privileged elements (constituents), usually yields particularly good results, if the non-privileged elements (constituents), are assigned zero value of energy. In particular circumstances, where it is acoustically justified to attenuate the non-privileged elements (constituents) assigning them a non-zero value, it is advantageous when all the non-privileged elements (constituents) are attenuated by the same amount, e.g. by 10 dB.

In another preferable embodiment of the invention, the privileged elements (constituents) of the audio signals are amplified (multiplied by a coefficient greater than 1) before being passed for the summation. Such amplification preferably aims at resulting in that the total energy value of amplified privileged elements (constituents) and the attenuated non-privileged elements (constituents) of the audio signals corresponds within ±10% tolerance to the total energy value of the respective elements (constituents) of the input audio signals before the processing.

It is also advantageous when the summation of the processed audio signals is performed in the time-frequency domain and a resulting mixed signal is next converted from time-frequency domain into the mixed output signal in the time domain. However, in certain cases it is also possible that the processed audio signals are first converted from time-frequency domain into the time domain processed signals and then summation of the time domain processed signals is performed yielding the mixed output signal in the time domain.

The apparatus for mixing audio signals according to the invention comprises a number of technical means which are in general operative to perform the steps of the method of mixing audio signals as described herein. The apparatus comprises means for converting digital individual input audio signals from time domain into the time-frequency domain, means for processing the individual audio signals in the time-frequency domain and means for summation of the processed audio signals into a mixed output signal, where the mixed output signal is a time domain signal. The means for processing the individual input audio signals in the time-frequency domain comprise means for identifying at least one privileged element of the audio signals in each corresponding time-frequency domain cell, means for attenuation of non-privileged elements of the audio signals and means for passing the processed audio signals for the summation. The apparatus in its preferred embodiments further comprises means for identifying the elements of the audio signals having the highest energy value in the specific time-frequency domain cell. Further, means for determining the areas consisting of the time-frequency domain cells. All these means are preferably a microprocessor programmed in such a way that the steps of the method according to the invention may be performed.

The method and apparatus according to the invention, are suitable both for monophonic and for multichannel, for example stereophonic, recordings and live sound systems. In the case of multichannel recordings and live sound systems the inventions are being applied independently to each of the channels.

Thanks to the invention, quite unexpectedly, a considerable improvement of the quality of recording is being achieved, particularly the amount of detail in the sound is increased. The signal mixed according to the invention is cleaner and in stereophonic recordings it is easier to sense the location of particular sound sources. Further it was unexpectedly noticed that when audio signals are mixed, in any small area of the time-frequency plane all respective parts of sounds can be removed except that of the audio signal with the highest energy in that area, and the quality of sound remains satisfactory. The invention is particularly useful for improving the recordings and live sound systems using many microphones simultaneously, where the so called microphone crosstalk is a problem. This invention also eliminates crosstalk substantially.

The method according to the invention is explained in the figures attached hereto.

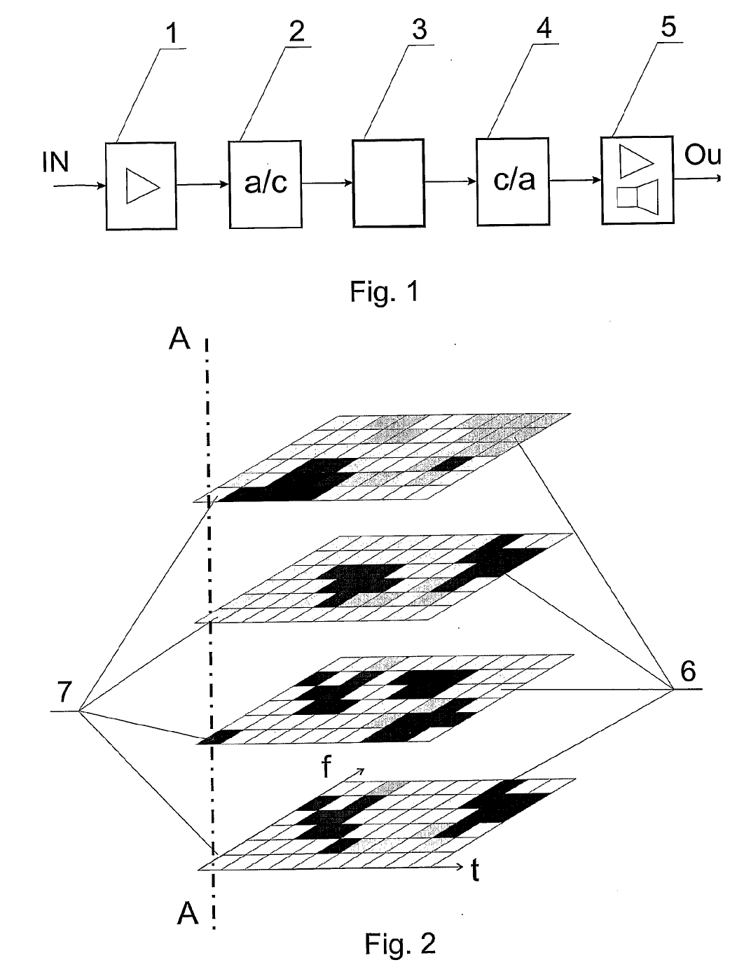

FIG. 1 is a block diagram of the apparatus for mixing the audio signals,

FIG. 2 is a graphical presentation of the process of identifying the privileged elements of the audio signals in the time-frequency domain cells and

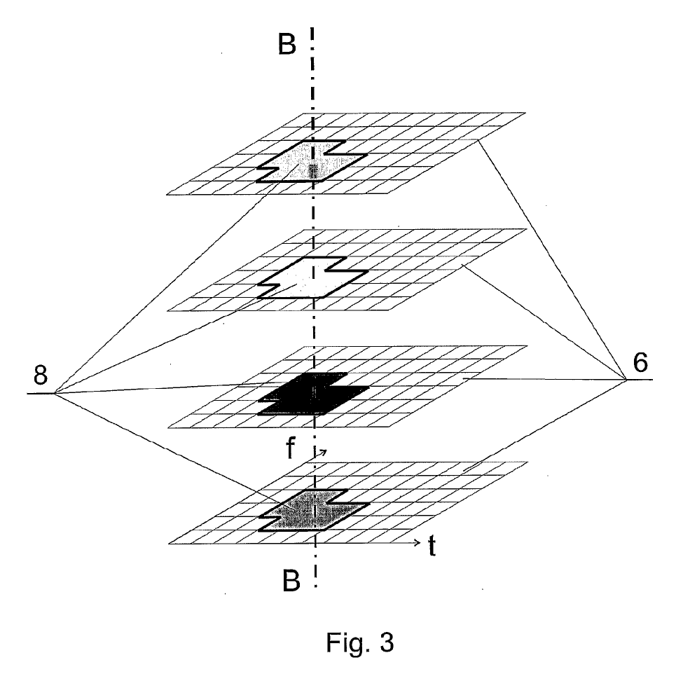

FIG. 3 is a graphical presentation of the process of identification of the privileged constituents in the areas.

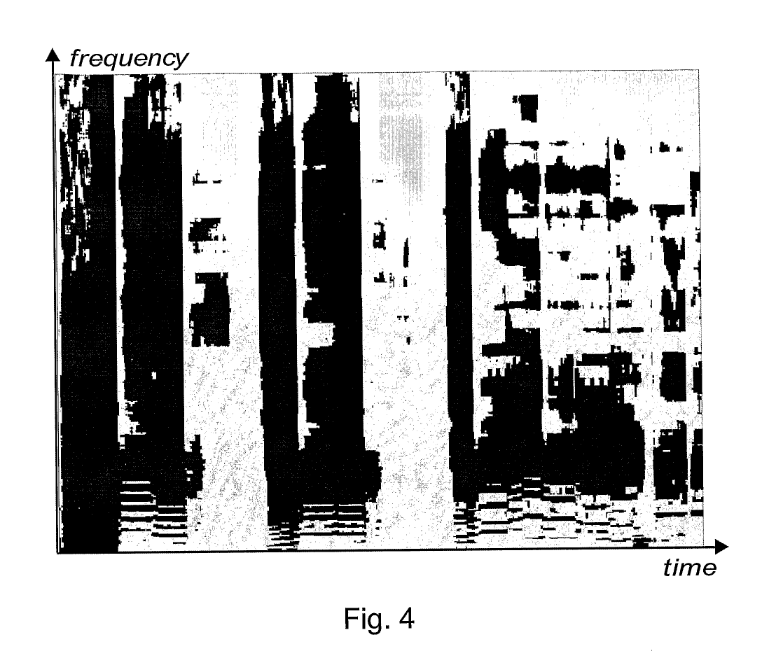

FIG. 4 represents time-frequency domain of a processed saxophone (black) audio signal and synthesizer audio signal (grey) in the time range of 7 seconds.

The individual input signals to be mixed are being received from microphones or from other sources of the signals. Each of the signals at the input IN can pass through a microphone preamplifier 1, and then is converted to the digital form in the analogue to digital (A/D) converter 2. The input audio signals in the digital form are being passed into the digital processor 3, where the processing according to the invention is being performed.

The digital processor can be a stand-alone device constructed specifically for this purpose, a PC computer extension card including a DSP processor, or a processor of a personal computer.

After the processing the digital signal is being passed to the digital to analogue (D/A) converter 4 and after the conversion to the electro-acoustic system containing amplifiers and loudspeakers 5.

If the presented method is being used for the production of a recording, then the signals from microphone preamplifiers 1 are at first recorded at separate tracks and then during the process of mixing are passed to the digital processor 3.

The mixed signal from the output of the digital processor 3 is recorded in the digital form. The sound can be decomposed into frequency components. The sounds of speech and music are time-varying and hence the appropriate method of analysis is in the time-frequency domain.

In FIG. 2 the time-frequency planes are shown. Each plane represents one audio signal in the time-frequency domain. If an audio signal lasts for 3 minutes then the number of indivisible time-frequency domain cells 7 reaches 8 million. In FIG. 2. the examples of four different audio signals (tracks) 6 in the time-frequency domain are presented. The individual squares in the time-frequency plane represent individual indivisible time-frequency domain cells 7. The values of the energy of elements of the audio signals in the time-frequency domain cells 7 are represented in a grey-scale. During the processing the elements of the audio signals 6 are compared for each time-frequency domain cell 7, which is indicated by the A-A line. In this specific embodiment only one privileged element of the audio signal is identified by choosing the darkest (having the greatest energy) square out of four squares (cells) 7 having the same address in the time-frequency plane. Further, the non-privileged elements of the audio signals 6 are attenuated to the value of zero. Such processed signals are next amplified so that the total energy value of amplified privileged elements and the attenuated non-privileged elements of the audio signals 6 corresponds to the total energy value of the respective elements of the input audio signals before the processing. The resulting processed audio signals are passed to the summing.

FIG. 3. illustrates the processing in which the areas composed of groups of time-frequency domain cells are being used. In the time-frequency planes of the signals 6 the determined areas 8 are shown. The values of energies in the areas 8 are first averaged for the specific audio signals 6 and are represented in a grey-scale. For better readability of this example, the other areas and their energies are not indicated. Identifying the privileged areas consists in comparing the averaged energy values (in grey-scale) of the different constituents of audio signals 6 (made up of the elements of the audio signals) in the area 8 as indicated by the B-B line.

FIG. 4 represents time-frequency domain of a processed saxophone (black) audio signal and synthesizer audio signal (grey) in the time range of 7 seconds.

1-15. (canceled)

16. A method of mixing audio signals comprising the steps of:
(a) converting digital individual input audio signals from time domain, into the time-frequency domain;
(b) processing the individual audio signals in the time-frequency domain, wherein the step of processing the individual audio signals in the time-frequency domain comprises the steps of:
(1) identifying at least one privileged element of the audio signals in each time-frequency domain cell;
(2) attenuating non-privileged elements of the audio signals;
(3) passing the processed audio signals for summation; and
(c) summing the processed audio signals into a mixed output signal, wherein the mixed output signal is a time domain signal.

17. The method of mixing audio signals according to claim 16, wherein the step of identifying at least one privileged element of the audio signals in each time-frequency domain cell consisting in choosing the element of the audio signals having the highest energy value in the specific time-frequency domain cell.

18. The method of mixing audio signals according to claim 17, wherein for each time-frequency domain cell there are no more than two privileged elements of the audio signals.

19. The method of mixing audio signals according to claim 18, wherein the time-frequency domain cells are grouped into areas and privileged constituents of the audio signals are identified for each area, the constituents of the audio signals being collection of the elements of audio signals pertaining to the specific area.

20. The method of mixing audio signals according to claim 19, wherein the areas consists of maximum 500 neighboring time-frequency domain cells.

21. The method of mixing audio signals according to claim 19, wherein the areas are determined by utilization of neural networks.

22. The method of mixing audio signals according to claim 19, wherein the areas are determined by utilization of fuzzy logic techniques.

23. The method of mixing audio signals according to claim 16, wherein before the step of identifying of the privileged elements of the audio signals, the energy values of the elements of the audio signals in the time-frequency domain cells of the area are averaged in the area.

24. The method of mixing audio signals according to claim 16, wherein before the step of identifying of the privileged elements of the audio signals, the energy values of the elements of the audio signals are multiplied by a coefficient with a value from 0.1 to 10.

25. The method of mixing audio signals according to claim 16, wherein the non-privileged elements of the audio signals are attenuated to the value of zero.

26. The method of mixing audio signals according to claim 16, wherein the privileged elements of the audio signals are amplified before the step of passing the processed audio signals for summation.

27. The method of mixing audio signals according to claim 26, wherein the total energy value of the amplified privileged elements and the attenuated non-privileged elements of the audio signals corresponds to the total energy value of the respective elements of the input audio signals before the processing within +/−10% tolerance.

28. The method of mixing audio signals according to claim 16, wherein the step of summing the processed audio signals is performed in the time-frequency domain and a resulting mixed signal is next converted from time-frequency domain into the mixed output signal in the time domain.

29. The method of mixing audio signals according to claim 16, wherein the processed audio signals are first converted from time-frequency domain into the time domain signals and then the step of summing the processed audio signals is performed yielding the mixed output signal in the time domain.

30. A method of mixing audio signals comprising the steps of:
(a) providing an apparatus for mixing audio signals comprising: an audio input device for receiving an audio signal; an analog to digital converter for converting the audio signal into digital form, the analog to digital convert being in communication with the audio input device; a digital processor in communication with the analog to digital converter, the digital processor being adapted to process the digital form audio signal; a digital to analog converter for converting the processed audio signal from the digital processor into analog form, the digital to analog converter being in communication with the digital processor; and an electro-acoustic system in communication with the digital to analog converter;
(b) converting digital individual input audio signals from time domain, into the time-frequency domain;
(c) processing the individual audio signals in the time-frequency domain, wherein the step of processing the individual audio signals in the time-frequency domain comprises the steps of:
(1) identifying at least one privileged element of the audio signals in each time-frequency domain cell;
(2) choosing the element of the audio signals having the highest energy value in the specific time-frequency domain cell.
(3) attenuating non-privileged elements of the audio signals;
(4) amplifying the privileged elements of the audio signals;
(5) passing the processed audio signals for summation; and
(d) summing the processed audio signals into a mixed output signal, wherein the mixed output signal is a time domain signal.

31. The method of mixing audio signals according to claim 30, wherein the total energy value of the amplified privileged elements and the attenuated non-privileged elements of the audio signals corresponds to the total energy value of the respective elements of the input audio signals before the processing within +/−10% tolerance.

32. The method of mixing audio signals according to claim 30, wherein the step of summing the processed audio signals is performed in the time-frequency domain and a resulting mixed signal is next converted from time-frequency domain into the mixed output signal in the time domain.

33. The method of mixing audio signals according to claim 30, wherein the processed audio signals are first converted from time-frequency domain into the time domain signals and then the step of summing the processed audio signals is performed yielding the mixed output signal in the time domain.

34. An apparatus for mixing audio signals comprising:
an audio input device for receiving an audio signal;
an analog to digital converter for converting the audio signal into digital form, the analog to digital convert being in communication with the audio input device;
a digital processor in communication with the analog to digital converter, the digital processor being adapted to process the digital form audio signal;
a digital to analog converter for converting the processed audio signal from the digital processor into analog form, the digital to analog converter being in communication with the digital processor; and
an electro-acoustic system in communication with the digital to analog converter.

35. The apparatus according to claim 34, wherein the digital processor further comprising: a means for converting the digital individual input audio signals from time domain into the time-frequency domain; a means for processing the individual audio signals in the time-frequency domain; a means for summation of the processed audio signals into a mixed output signal, where the mixed output signal is a time domain signal; and wherein the means for processing the individual input audio signals in the time-frequency domain comprise a means for identifying at least one privileged element of the audio signals in each corresponding time-frequency domain cell, a means for attenuation of non-privileged elements of the audio signals, and a means for passing the processed audio signals for the summation.
